(19) United States
(12) Patent Application Publication
(10) Pub. No.: US 2005/0028084 A1
(43) Pub. Date: Feb. 3, 2005

(54) System and method for a form validation engine

(76) Inventor: Alan Dziejma, Nashua, NH (US)

Correspondence Address: AKC PATENTS, 215 GROVE ST., NEWTON, MA, 02466, US

(21) Appl. No.: 10/900,218

(22) Filed: Jul. 27, 2004

Related U.S. Application Data
(60) Provisional application No. 60/490,590, filed on Jul. 28, 2003.

(51) Int. Cl. G06F 17/00

(52) U.S. Cl. 715/505

(57) ABSTRACT

The invention features a method of validating one or more fields in a form. The method includes connecting a client machine to a server via a network connection and downloading a form and a form validation engine from the server to the client machine. The form includes one or more fields and each field comprises one or more embedded markers associated with one or more form validation functions comprised in the form validation engine, respectively. Each of the one or more functions comprises one or more validation criteria. Next, entering data in the one or more fields and submitting the form with the data to be validated by the form validation engine in the client machine. Finally, validating the form by executing executable instructions comprised in the form validation engine. The executable instructions identify the one or more field embedded markers in the one or more fields of the form and call and execute the associated one or more form validation functions upon the data in the one or more fields, respectively.

### CROSS REFERENCE TO RELATED CO-PENDING APPLICATIONS

This application claims the benefit of U.S. provisional application Ser. No. 60/490,590 filed on Jul. 28, 2003 and entitled SYSTEM AND METHOD FOR A FORM VALIDATION ENGINE, which is commonly assigned and the contents of which are expressly incorporated herein by reference.

### FIELD OF THE INVENTION

The present invention relates to a system and a method for performing form validation in a distributed computing system.

### BACKGROUND OF THE INVENTION

Referring to FIG. 1, a typical web-based distributed computing environment 400 includes a web server 410 and several client machines 420 accessing the web-server via an Internet connection 145. The web server 410 contains data 402 and computer applications 404 and is adapted to send out data and computation results produced by the computer applications to the various client machines in the form of web pages. Web pages are usually written in a markup language, such as Hypertext Markup Language (HTML) or Extensible Markup Language (XML). The client machine 420 receives these web pages 405 and displays them to a user through a web browser 422.

In some cases an HTML web page 405 contains a form that requires user input. One example is when placing an order for purchasing a product over the web, entering a user's name, shipping address, phone number, e-mail address and payment information. These HTML forms contain one or more fields 407 that require direct input by the user. These fields are identified by special markup tags contained within the form and also include labels 408 that describe what type of input is required. A markup tag or a marker is a command that specifies how the field, or the document, or a portion of the document, should be formatted.

Typically, a user fills out the required input fields and clicks on the electronic button “submit” 409. This action sends the filled out HTML form 405 back to the web server 410 via the Internet 145 and the web server 410 runs an application 404 that checks if the form was filled out correctly, i.e., if all inputs are included and if they have the correct form. The application that performs this checking of the submitted form is a form validation engine (FVE). If the form was filled out correctly, the FVE sends a message to the client machine that the form was accepted. Otherwise, the FVE sends a message to the client machine that the form contains invalid or missing input data.

This process is time consuming, inefficient and requires large bandwidth for sending back and forth HTML forms that contain multiple markup tags and user input data. In some cases when the user does not have the web browser of the client machine set correctly to provide caching, i.e., storing of a previously filled out form, the entire form needs to be filled out again and resubmitted when there is a need to correct a few input fields.

Some applications provide custom client-side scripting, i.e., custom programming, that gets downloaded to the client machine together with the form and does form validation for each field at the client machine. However, users are often concerned about downloading client-side scripting to their client machines because of the potential of receiving computer viruses during this process. Furthermore, a separate custom program is required for each separate form and field and this results in a large number of programs that need to be downloaded that are usually used only once.

Accordingly, there is a need for a fast and efficient form validation engine that can validate HTML forms in a distributed web based computing environment without requiring large bandwidth or custom programming for each input field of a form.

### SUMMARY OF THE INVENTION

In general, in one aspect, the invention features a method of validating one or more fields in a form. The method includes connecting a client machine to a server via a network connection and downloading a form and a form validation engine from the server to the client machine. The form includes one or more fields and each field comprises one or more embedded markers. The form validation engine includes one or more functions associated with the one or more field embedded markers, respectively, and each of the one or more functions comprises one or more validation criteria. Next, entering data in the one or more fields and submitting the form with the data to be validated by the form validation engine to the client machine. Finally, validating the form by executing executable instructions comprised in the form validation engine by the client machine. The executable instructions identify the one or more field embedded markers in the one or more fields of the form and call and execute the one or more form validation functions upon the data in the one or more fields, respectively.

Implementations of this aspect of the invention may include one or more of the following features. The one or more field embedded markers comprise a “valid” marker that specifies the type of validation to be performed on the one or more fields where the marker is embedded. The “valid” marker may begin with an exclamation mark “!” thereby defining the one or more fields where the “valid” marker is embedded as fields that are required to contain data for the form to be accepted. The one or more field embedded markers comprises a “msg” marker that holds an error message to be displayed when the data in the one or more field do not meet the one or more validation criteria. The one or more field embedded markers comprise a “user” marker that indicates a name for the one more field to be displayed in the error message. The one or more functions comprise instructions for checking if a variable has a value outside of a certain range. The one or more functions comprise instructions for checking if a variable is a string of digits between 0 and 9. The one or more functions comprise instructions for checking if a variable is a string of characters comprised within a set of previously defined characters. The one or more functions comprise instructions for scanning the one or more fields, identifying the one or more embedded “valid” markers and checking type of data in the one or more fields, respectively. The type of data may be Date, String, Dollar, Email, Number, Percent, Name, Business, Phone, Fax, and Social Security Number. The form is written using a markup language and the markup language may be Hypertext Markup Language (HTML), HTML related markup languages, XML, XML related languages, XUL (XML User Interface Language), SVG (Scalable Vector Graphics), Xforms, text, or combinations thereof. The form validation engine is written using an object oriented programming language and the object-oriented programming language may be Java, JavaScript, J#, C#, C+, C++, Visual Basic, ActionScript, XSL, XQuery, or XPath. The method may further comprise notifying a user as soon as an error is detected within any of the one or more fields. The network connection is the Internet. The form is displayed within a browser in the client machine.

In general, in another aspect, the invention features a distributed computing system including a client machine and a server. The client machine connects to the server via a network connections, downloads a form and a form validation engine from the server to the client machine, receives data entered in one or more fields of the form by a user and performs validation of the entered data. The validation includes executing executable instructions comprised in the form validation engine and the executable instructions identify one or more field markers embedded in the one or more fields of the form and call and execute one or more form validation functions upon the data in the one or more fields, respectively. The one or more functions comprise one or more validation criteria.

Among the advantages of this invention may be one or more of the following. The FVE extends the syntax of basic HTML to allow validation of form fields without custom JavaScript programming for each field. The invention defines three new tags that are embedded in the HTML field definitions and a general Javascript code that defines four functions that perform the form validation tasks. The FVE code is applicable to all forms that contain the embedded new tags. This eliminates the need to do custom programming for validating the input in each HTML field. Furthermore, the FVE provides a dramatic reduction in the bandwidth requirement of the information flowing from the server to the client machine because validation is done on the client machine and not transmitted over the network and because the HTML form does not contain large amounts of Javascript code for each input field. The FVE also provides a dramatic improvement in the apparent system responsiveness as seen by the user because the filled out HTML form does not have to go back and forth from the client machine to the server for validation. The FVE also provides a dramatic reduction in the amount of HTML coding required on the part of developers since the general FVE code handles all field validation tasks. This allows programmers unskilled in Javascript programming to develop HTML forms that include form validation by embedding the three new tags.

### BRIEF DESCRIPTION OF THE DRAWINGS

FIG. 1 is a block diagram of a distributed web-based computing system;

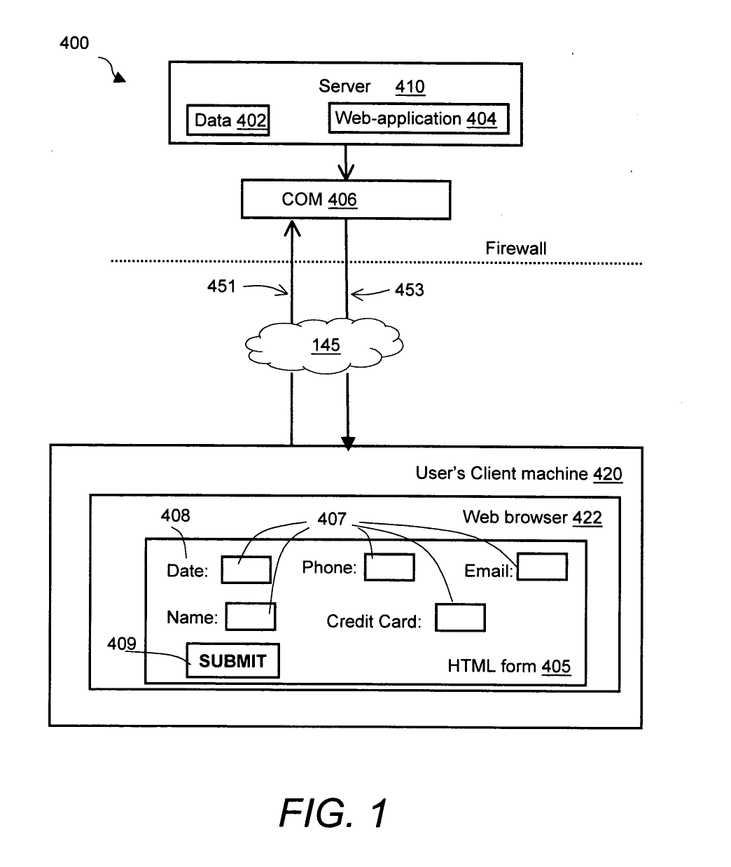

FIG. 2 is an overview diagram of a business payment system (BPC™) that utilizes the Form Validation Engine (FVE) of this invention;

FIG. 3 is a screen shot of a new order form accessible through the BPC™ system of FIG. 2;

FIG. 4 is a screen shot of a new business referral form accessible through the BPC™ system of FIG. 2;

FIG. 5 is a schematic diagram of an HTML form with the embedded markers in each field;

FIG. 6 is a schematic block diagram of the FVE code;

FIG. 7 is a screen shot of the BPC™ system User Administrator form where the input was not accepted because of errors in the zip, phone number, and fax number fields and the missing information in the required business field; and

FIG. 8 is a screen shot of the error message received when the form of FIG. 8 went through the FVE.

### DETAILED DESCRIPTION OF THE INVENTION

The invention describes a Form Validation Engine (FVE) that defines and uses three new tags and an application code for performing form validation on the client side of a distributed computing system. The application code includes four new form validation functions that perform the various form validation tasks. The three new tags get embedded in the HTML form fields and when the FVE encounters these new tags it calls upon the four new form validation functions to perform form validation tasks in the client machine.

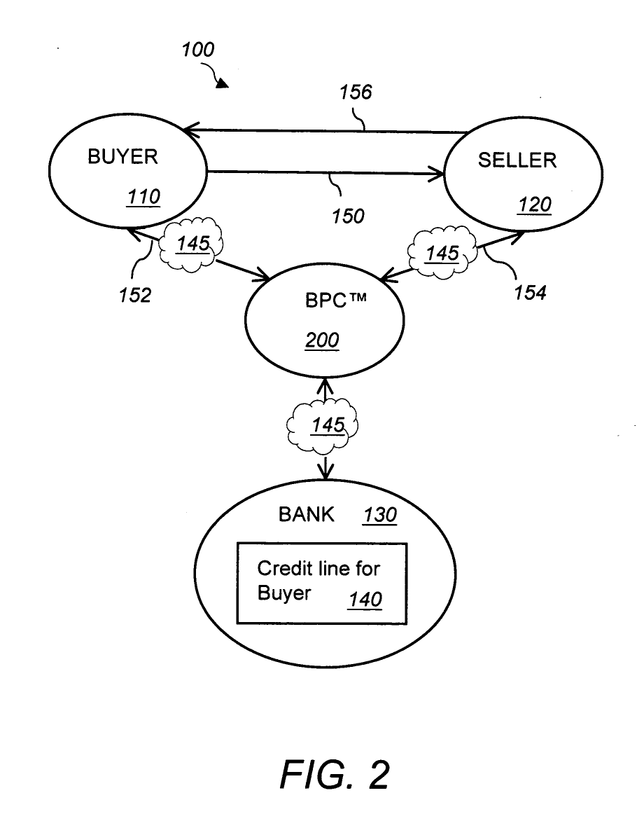

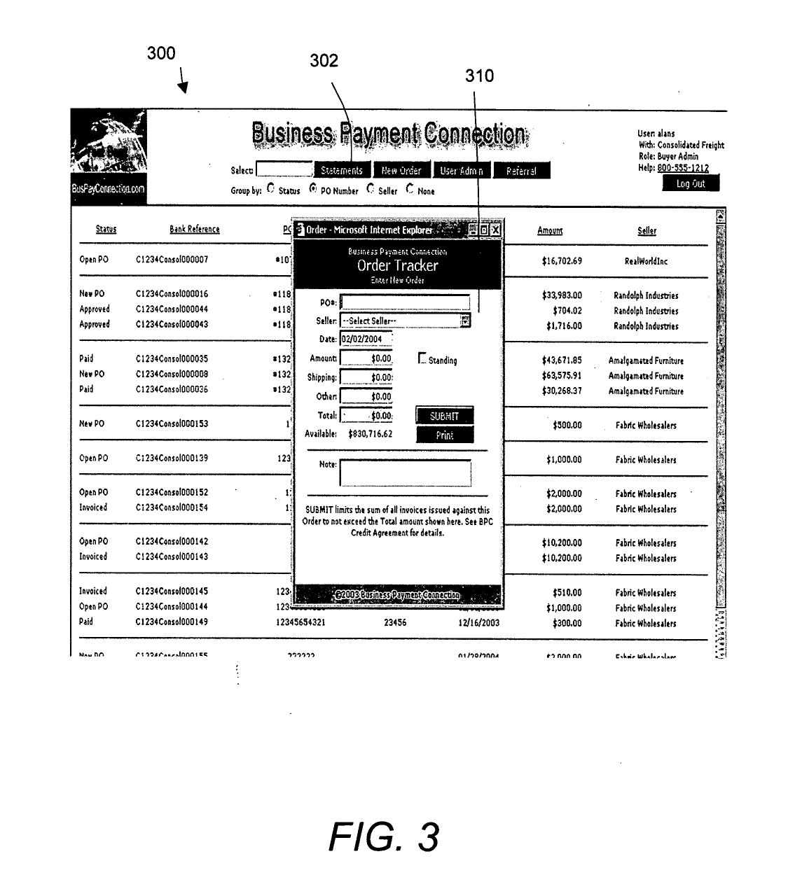

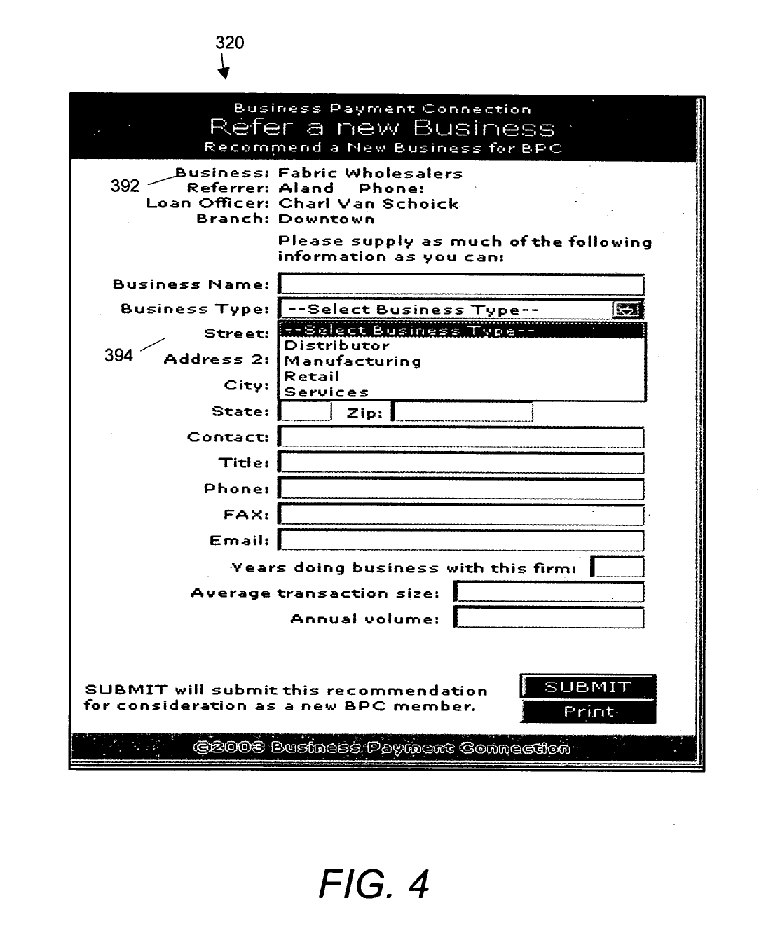

The FVE will be described in connection with a distributed business payment system 100 described in a co-pending patent application entitled “System and method for a business payment connection” the contents of which are expressly incorporated herein by reference. Referring to FIG. 2, a distributed business payment system 100 includes a buyer 110, a seller 120 and a bank 130. The buyer 110 places a purchase order for a good or a service to the seller 120 (150). The purchase order is placed directly in a face-to face transaction. Alternatively, the order may be placed remotely, via the Internet, the phone or by mail. The seller 120, the buyer 110 and the bank 130 are connected via the Internet 145 to the BPC™ system server 200. The bank 130 provides a credit line 140 to the buyer 110 and this credit line is used to pay the seller 120 for goods and services. The seller 120 receives the purchase order from the buyer 110 and then invoices the buyer 110 and ships the requested good or provides the service (156). The buyer 110 approves the invoice and instructs the bank 130 to pay the seller 120 via the previously arranged credit line 140 (152). The bank 130 pays the invoiced amount to the seller 120 after subtracting a transaction fee from the invoiced amount (154). The business payment process is facilitated by a Business Payment Connection™ (BPC™) application stored in the web server 200 and is accessed by the buyer 110, the seller 120, and the bank 130 via the Internet 145. The access can be direct by using the URL address “www.buspayconnection.com” through the Microsoft Internet Explorer web browser or through a link off the bank's website. The BPC™ application includes a dashboard user interface screen 300, shown in FIG. 3. Dashboard 300 is the user's homepage for all activities and provides a collaborative view of all transactions for the buyer, seller and the bank. Dashboard 300 also includes function buttons 302 that bring up pop-up windows when a user clicks them. These windows include HTML forms that require user input. Examples of these HTML forms associated with the BPC™ application, include “new order” 310, and “referral” 320 shown in FIG. 3, and FIG. 4, respectively. The forms 310, 320 are written in HTML language and are accessed through an Internet connection 145 via a web browser, such as the Internet Explorer.

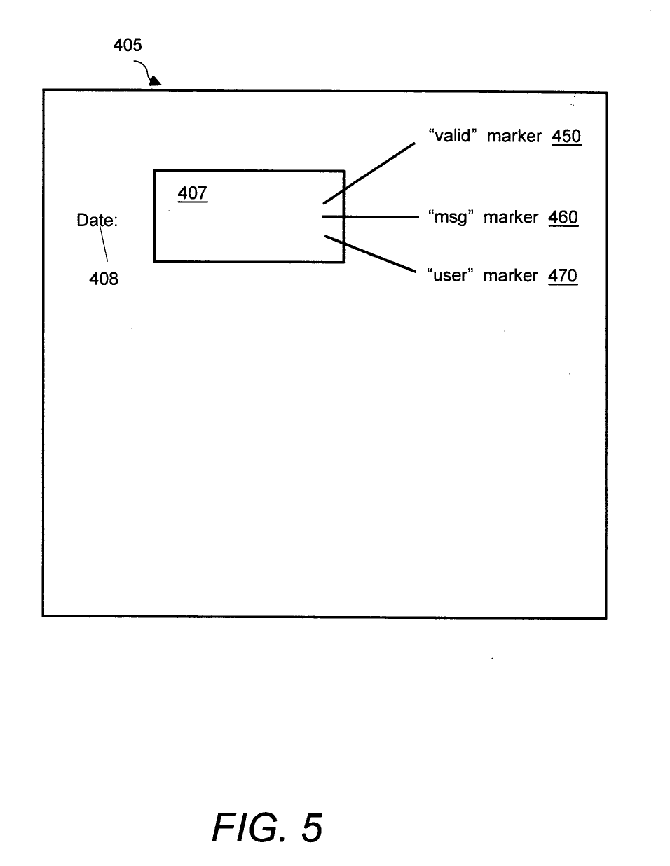

Referring to FIG. 5, in each input field definition 407 of the HTML form 405 three new markers 450, 460, and 470 are embedded. These markers are: “valid” 450, “msg” 460, and “user” 470. The “valid” marker 450 specifies what kind of validation is to be performed on the field. If the “valid” marker 450 begins with the ! mark, then that field is a required field and must be filled in for the form to be accepted. The “msg” marker 460 holds the error message to be displayed if the field does not meet the indicated validation criteria. The “user” marker 470 indicates the name of the field to be displayed in the error message. This marker is optional and if not provided, the FVE will use the HTML specified name of the field as the name of the field in error messages. In the example of FIG. 5 the HTML specified name for field 407 is “Date” 408.

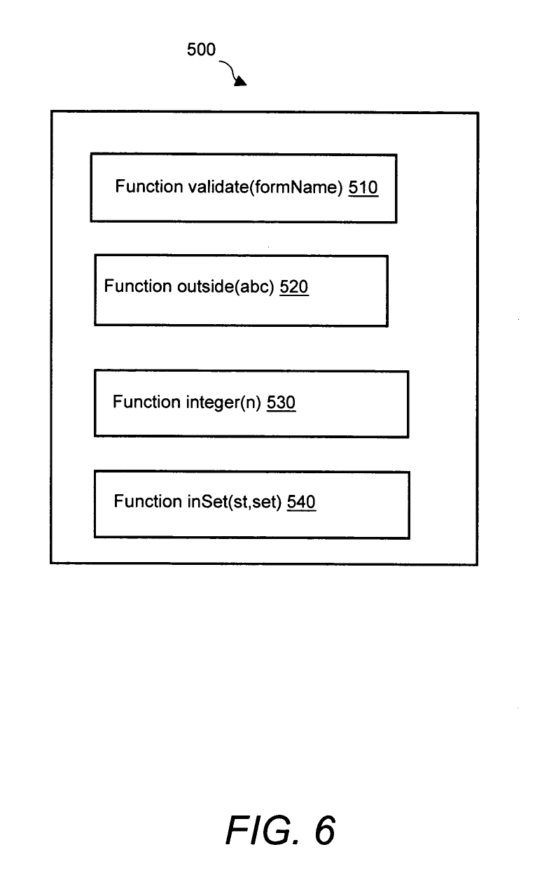

The HTML form 405 with the embedded three new markers 450, 460, 470 in each field 407 is downloaded together with an FVE application code from the server 410 to the user's client machine 420 when the form is requested by the user. Referring to FIG. 6, the FVE application code 500 defines and uses four new functions to perform validation of the field data. These new functions include Function validate(formName) 510, Function outside(a,b,c) 520, Function integer(n) 530, and Function inSet(st,set) 540.

Function validate(formName) 510 is the main engine which provides validation services on all marked fields in an HTML form definition by scanning the fields looking for a “valid=” tag and checking the following types:
Date—field must hold a valid date
String—field must be a valid string using characters form the set of A-Z, a-z, 0-9, and punctuation.
Dollar—field must hold a dollar value.
Email—field must hold a valid email address
Number—field must hold a number
Percent—field must hold a percent
Name—field must hold a person's name
Business—field must hold a business name
Phone—field must hold a phone number
Fax—field must hold a fax number
Ssn—field must hold a Social Security Number

Function outside (a, b, c) 520 is a utility function that indicates if b lies outside the range a to c.

Function integer (n) 530 is a test for a string consisting only of the digits 0 to 9

Function inSet (st, set) 540 is a test for a string comprised of characters from a set of characters.
An implementation of the FVE 500 with these four functions, Function validate(formName) 510, Function outside(a,b,c) 520, Function integer(n) 530, Function inSet(st,set) 540, written in Javascript is shown in Appendix A. In other embodiments, the FVE is written in other object oriented programming languages including Java, JavaScript, J#, C#, C+, C++, Visual Basic, ActionScript, XSL, XQuery, and XPath, among others. In other embodiments, the form 405 is written using other markup languages including XML, XML related languages, HTML related languages, XUL (XML User Interface Language), SVG (Scalable Vector Graphics), Xforms, text, and combinations thereof, among others. The described form validation method may be also used on the server for performing server-side validation alone or in addition to the client-side validation. In that case the form validation engine resides in the server and the form with the embedded markers and data is submitted to the server either locally or via the network connection.

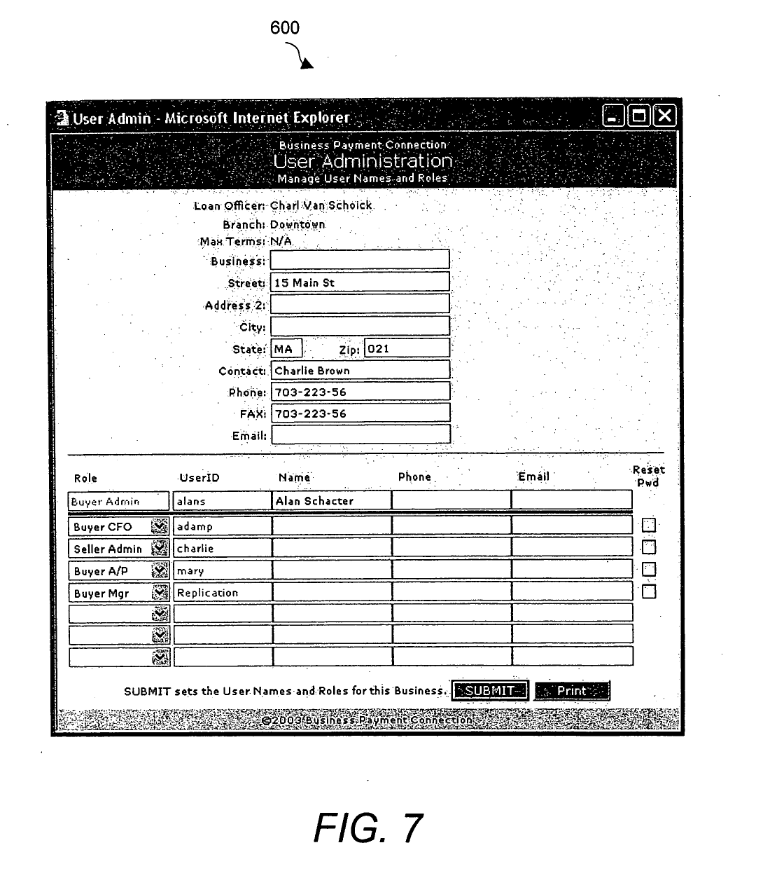

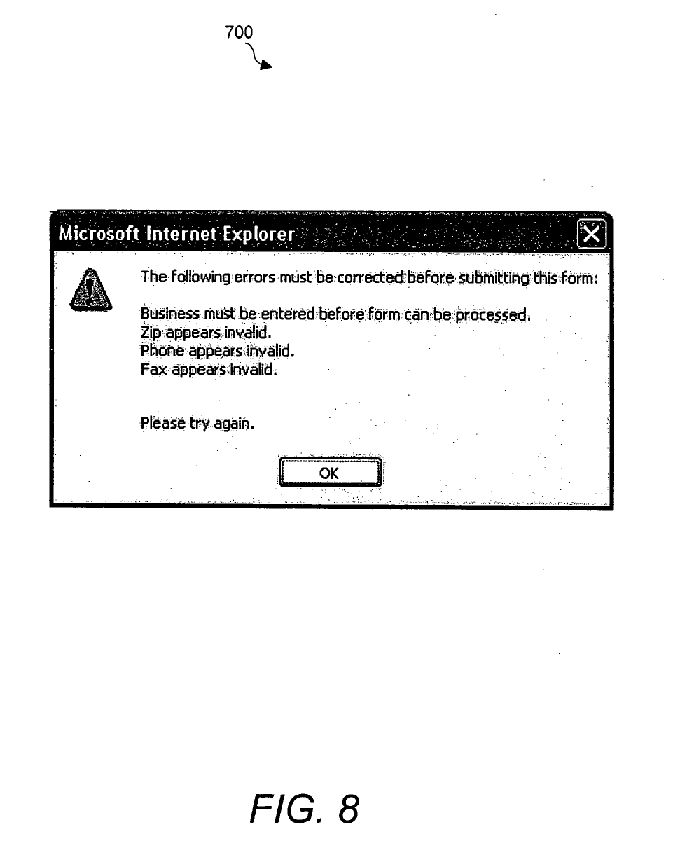

As was mentioned above, when a user requests a form 405, both the HTML form 405 and the FVE code 500 are downloaded from the server 410 to the user's client machine 420. The user fills out form 405 and clicks the submit button. This action starts the execution of the FVE application on the client machine. The FVE searches all fields that have the embedded markers and performs the corresponding validation checks. If all required fields are filled out correctly the FVE sends a message “Form accepted”. If there are errors in the various fields the FVE sends a message indicating the location and type of error. Referring to FIG. 7, BPC™ form 600 for a User Administrator contained errors in the phone number, fax number and the zip code. Furthermore, in this form the Business field is a required, i.e., it needs to be filled out for the form to be accepted. After clicking on the form submit button, the FVE performed form validation and returned the error message 700 shown in FIG. 8, “The following errors must be corrected before submitting this form: Business must be entered before form can be processed. Zip appears invalid. Phone appears invalid. Fax appears invalid Please try again” By clicking the OK button the user returns to the previously filled out form with all the previously filled data and corrects the field errors.

Several embodiments of the present invention have been described. Nevertheless, it will be understood that various modifications may be made without departing from the spirit and scope of the invention. Accordingly, other embodiments are within the scope of the following claims.

APPENDIX A
FVE CODE

```
<HTML>
<HEAD>
<TITLE>Validation Engine -- Property of Collaborative Financial Concepts LLC --
&copy; 2003 All Rights Reserved</TITLE>
<SCRIPT language=JavaScript>
function outside(a,b,c) { if (1*a>1*b) return true; if (1*b>1*c) return true;
return false; }
function integer(n) { var stn=‘’+n; for (var i=0;i<stn.length;i++) if
((stn.charAt(i)<‘0’)||(stn.charAt(i)>‘9’)) return false; return true; }
function inSet(st,set) { var str=‘’+st; for (var i=0;i<str.length;i++) if
(set.indexOf(str.charAt(i))<0) return false; return true; }
function validate(formName) { var
msg=‘’ ,fieldName,fieldUser,fieldVal,fieldValid,fieldReq,fieldMsg,charCode,goodC
har,day,month,year,ndx,work,cents;
  for (var fld=0;fld<formName.elements.length;fld++) {
    fieldName=formName.elements[fld].name;
    fieldUser=formName.elements[fld].user; if
(typeof(fieldUser)==‘undefined’) fieldUser=fieldName;
    fieldValue=formName.elements[fld].value;
    fieldValid=formName.elements[fld].valid;
    fieldMsg=formName.elements[fld].msg; if (typeof(fieldMsg)==‘undefined’)
fieldMsg=fieldUser+‘ appears invalid.’; fieldMsg+=‘\n’;
```

| | |
|---|---|
| if (typeof(fieldValid)==‘undefined’) continue; | // skip any |

fields without a validation request
if (fieldValid.charAt(0)==‘!’) { fieldValid=fieldValid.slice(1);
fieldReq=true; } else fieldReq=false; // required flag

| | |
|---|---|
| if (fieldReq) { | // assure |

```
that required fields have some value entered
      if (fieldValue==‘’) msg+=fieldUser+‘ must be entered before form
can be processed.\n’;
    }
```

| | |
|---|---|
| if (typeof(fieldValue!=‘undefined’)&&(fieldValue!=‘’)) { | // |
| only validate fields with values | |
| goodChar=true; | |
| for (var j=0;j<fieldValue.length;j++) { | |
| // check for valid characters | |
| if (outside(32,fieldValue.charCodeAt(j),126)) { | |
| msg+=‘An illegal character was entered in field | |
| ’+fieldUser+‘.\n’; goodChar=false; break; | |
| } | |
| } | |
| if (goodChar) { | |
| // only process fields with valid characters | |
| switch(fieldValid) { | |
| case ‘string’: | |
| // no test!!! | |
| break; | |
| case ‘dollar’: | |
| work=fieldValue.replace(/[\+\−\$\,]/g,‘’); | |
| // remove all non digit characters except spaces | |
| if (isNaN(work)) { msg+=fieldMsg; break; } | |
| // must be only digits with leading or trailing spaces | |
| ndx=fieldValue.indexOf(‘.’); | |
| // check for valid cents, may have trailing spaces | |
| if (ndx>0) { | |
| cents=fieldValue.slice(ndx+1); | |
| if (isNaN(cents)) { msg+=fieldMsg; break; } | |
| if ((1*cents>99)\|\|(1*cents<0)) { msg+=fieldMsg; break; | |
| } | |
| fieldValue=fieldValue.slice(0,ndx); | |
| // remove cents portion if present | |
| } | |
| fieldValue=fieldValue.replace(/[ ]/g,‘’); | |
| // remove all spaces | |
| if (fieldValue.lastIndexOf(‘−’)>0) { msg+=fieldMsg; break; | |
| } // optional − or + must be first character | |
| if (fieldValue.lastIndexOf(‘+’)>0) {msg+=fieldMsg; break; | |
| } | |
| fieldValue=fieldValue.replace(/[+−]/g,‘’); | |
| // remove + or − | |
| if (fieldValue.lastIndexOf(‘$’)>0) { msg+=fieldMsg; break; | |
| } // optional $ must be first character | |
| fieldValue=fieldValue.replace(/[$]/g,‘’); | |
| // remove $ | |
| if (fieldValue.indexOf(‘,’)>=0) { | |
| // iff commas are present, insist on correct spacing | |
| // 1,23 1,,234 ,123 1,2345 | |
| if (fieldValue.charAt(0)==‘,’) { msg+=fieldMsg; break; | |
| } // ,123 | |
| work=fieldValue.replace(/,\d{3}/g,‘’); | |
| // remove ,ddd | |
| if (work.indexOf(‘,’)>0) { msg+=fieldMsg; break; } | |
| // no commas should remain | |
| for (i=fieldValue.length−4;i>0;i−=3) { | |
| // since commas are present, they must be spaced every 3 digits from end | |
| if (fieldValue.charAt(i)!=‘,’) { msg+=fieldMsg; | |
| break } | |
| } | |
| } | |
| break; | |
| case ‘date’: | |
| if ((fieldValue.length<6)\|\|(fieldValue.length>10)) { | |
| msg+=fieldMsg; break; } // must be in form mm/dd/yyyy | |
| if (!inSet(fieldValue, ‘0123456789/’)) { msg+=fieldMsg; | |
| break; } // only allow digits and / | |
| ndx=fieldValue.indexOf( ‘/’); | // |
| get position of first slash | |
| month=fieldValue.slice(0,ndx); | |
| fieldValue=fieldValue.slice(ndx+1); | |
| ndx=fieldValue.indexOf(‘/’); | // |
| get position of second slash | |
| day=fieldValue.slice(0,ndx); | |
| year=fieldValue.slice(ndx+1); | |
| if (isNaN(day)\|\|isNaN(month)\|\|isNaN(year)) { msg+=fieldMsg; | |
| break; } // all subfields must be numbers | |
| if (year.length<4) { if (year<50) year=‘20’+year; else | |
| year=‘19’+year; } | |
| if | |
| (outside(1,day,31)\|\|outside(1,month,12)\|\|outside(1990,year,2010)) { | |
| msg+=fieldMsg; break; } | |
| var d=new Date(year,month−1,day); | // |
| verify that day is valid for month/year given | |
| if (d.getDate( )!=day) { msg+=fieldMsg; break; } | |
| break; | |
| case ‘email’: | |
| if ((fieldValue.indexOf(‘@’)<0)\|\|(fieldValue.indexOf(‘ | |
| ’)>=0)\|\|(fieldValue.lastIndexOf(‘.’)<fieldValue.indexOf(‘@’))) { | |
| msg+=fieldMsg; | |
| } | |
| break; | |
| case ‘number’: | |
| if (isNaN(fieldValue)) msg+=fieldMsg; | |
| break; | |
| case ‘name’: | |
| if (!inSet(fieldValue,“ | |

```
abcdefghijklmnopqrstuvwxyzABCDEFGHIJKLMNOPQRSTUVWXYZ‘−.’”)) msg+=fieldMsg;
        break;
      case ‘business’:
        if (!inSet(fieldValue,“
abcdefghijklmnopqrstuvwxyzABCDEFGHIJKLMNOPQRSTUVWXYZ‘−0123456789&,./”))
msg+=fieldMsg;
        break;
      case ‘phone’:
```

| | |
|---|---|
| fieldValue=fieldValue.replace(/\D/g,‘’); | // |
| remove all non digit characters | |
| if (fieldValue.length<10) msg+=fieldMsg; | // |
| minimum length of 10 digits -- allow extension | |
| break; | |
| case ‘ssn’: | |
| if (fieldValue.indexOf(‘−’)>=0) { | // |
| insist on a − in the 3rd and 6th position | |
| if ((fieldValue.charAt(3)!=‘− | |
| ’)\|\|(fieldValue.charAt(6)!=‘−’)) { msg+=fieldMsg; break; } | |
| fieldValue=fieldValue.slice(0,3)+fieldValue.slice(4,6)+fieldValue.slice(7); | // |
| remove − | |
| } | |
| if (!inSet(fieldValue, “0123456789”)) { msg+=fieldMsg; | |
| break; } // only allow digits | |
| if (fieldValue.length!=9) msg+=fieldMsg; | // |
| length must be 9 digits | |
| break; | |
| case ‘percent’: | |
| if (isNaN(fieldValue)) msg+=fieldMsg; | // |
| insist on number | |
| break; | |
| default: | |
| if (typeof(fieldValid)!=‘undefined’) | |
| msg+=‘Internal error: ‘+fieldUser+’ has | |
| “‘+fieldValid+’” as validation keyword. Please contact support.\n’; | |
| break; | |
| } | |
| } | |
| } | |
| } | |
| if (msg!=‘’) { alert(‘The following errors must be corrected before | |
| submitting this form:\n\n’+msg+‘\n\nPlease try again.’); return; } | |
| alert(‘Form accepted.’); | |
| // formName.submit( ) | |
| } | |
| // --> | |
| </SCRIPT> | |
| </HEAD> | |
| <BODY bgcolor=#ffffff> | |
| <h2>Validation Engine Test Page</h2> | |
| <form action=“” method=“post” name=“frm”> | |
| <table> | |
| <tr><td align=right><b>Required</b></td></tr> | |
| <tr><td align=right>Date:</td><td><input type=text name=‘date’ valid=‘!date’ | |
| msg=‘Date must be in the form mm/dd/yyyy’></td></tr> | |
| <tr><td align=right><b>Optional</b></td></tr> | |
| <tr><td align=right>String:</td><td><input type=text name=‘string’ | |
| valid=‘string’ msg=‘Invalid string’></td></tr> | |
| <tr><td align=right>Dollar:</td><td><input type=text name=‘dollar’ | |
| valid=‘dollar’ msg=‘Invalid dollar amount’></td></tr> | |
| <tr><td align=right>Email:</td><td><input type=text name=‘email’ valid=‘email’ | |
| msg=‘Invalid email address’></td></tr> | |
| <tr><td align=right>Number:</td><td><input type=text name=‘number’ | |
| valid=‘number’ msg=‘Invalid number’></td></tr> | |
| <tr><td align=right>Percent</td><td><input type=text name=‘percent’ | |
| valid=‘percent’ msg=‘Invalid percent’></td></tr> | |
| <tr><td align=right>Name:</td><td><input type=text name=‘name’ valid=‘name’ | |
| msg=‘Invalid name’></td></tr> | |
| <tr><td align=right>Business:</td><td><input type=text name=‘business’ | |
| valid=‘business’ msg=‘Invalid business name’></td></tr> | |
| <tr><td align=right>Phone:</td><td><input type=text name=‘phone’ valid=‘phone’ | |
| msg=‘Phone number must be in the form ddd-ddd-dddd followed by an optional | |
| extension’></td></tr> | |
| <tr><td align=right>SSN:</td><td><input type=text name=‘ssn’ valid=‘ssn’ | |
| msg=‘Invalid Social Security Number’></td></tr> | |
| <tr><td></td><td align=center><input type=button value=“Submit” | |
| onclick=“validate(frm)”> | |
| </table> | |
| </form> | |
| </BODY> | |
| </HTML> | |

1. In a distributed computing system comprising a client machine and a server, a method of validating one or more fields in a form comprising:
connecting said client machine to said server via a network connection;
downloading said form and a form validation engine from said server to said client machine via said network connection, wherein each of said one or more fields comprises one or more embedded markers and said form validation engine comprises one or more functions associated with said one or more field embedded markers, respectively, and wherein each of said one or more functions comprises one or more validation criteria;
entering data in said one or more fields and submitting said form with said data to be validated by said form validation engine to said client machine;
validating said form by executing executable instructions comprised in said form validation engine by said client machine wherein said executable instructions identify said one or more field embedded markers in said one or more fields of said form and call and execute said one or more form validation functions upon said data in said one or more fields, respectively.

2. The method of claim 1 wherein said one or more field embedded markers comprise a “valid” marker that specifies the type of validation to be performed on said one or more fields where said marker is embedded.

3. The method of claim 2 wherein said “valid” marker begins with an exclamation mark “!” thereby defining said one or more fields where said “valid” marker is embedded as fields that are required to contain data for the form to be accepted.

4. The method of claim 1 wherein said one or more field embedded markers comprise a “msg” marker that holds an error message to be displayed when said data in said one or more field do not meet said one or more validation criteria.

5. The method of claim 4 wherein said one or more field embedded markers comprise a “user” marker that indicates a name for said one more field to be displayed in said error message.

6. The method of claim 1 wherein said one or more functions comprise instructions for checking if a variable has a value outside of a certain range.

7. The method of claim 1 wherein said one or more functions comprise instructions for checking if a variable is a string of digits between 0 and 9.

8. The method of claim 1 wherein said one or more functions comprise instructions for checking if a variable is a string of characters comprised within a set of previously defined characters.

9. The method of claim 2 wherein said one or more functions comprise instructions for scanning said one or more fields, identifying said one or more embedded “valid” markers and checking type of data in said one or more fields, respectively.

10. The method of claim 9 wherein said type of data is selected from a group consisting of Date, String, Dollar, Email, Number, Percent, Name, Business, Phone, Fax, and Social Security Number.

11. The method of claim 1 wherein said form is written using a markup language.

12. The method of claim 11 wherein said markup language is selected from a group consisting of Hypertext Markup Language (HTML), HTML related markup languages, XML, XML related languages, XUL (XML User Interface Language), SVG (Scalable Vector Graphics), Xforms, text, and combinations thereof.

13. The method of claim 1 wherein said form validation engine is written using an object oriented programming language.

14. The method of claim 13 wherein said object-oriented programming language is selected from a group consisting of Java, JavaScript, J#, C#, C+, C++, Visual Basic, ActionScript, XSL, XQuery, and XPath.

15. The method of claim 1 further comprising notifying a user as soon as an error is detected within any of said one or more fields.

16. The method of claim 1 wherein said network connection comprises the Internet.

17. The method of claim 1 wherein said form is displayed within a browser in the client machine.

18. The method of claim 1 further comprising submitting said form with said data to said server to be validated by said form validation engine.

19. A distributed computing system comprising a client machine and a server, wherein said client machine connects to said server via a network connections, downloads a form and a form validation engine from said server to said client machine, receives data entered in one or more fields of said form by a user and performs validation of said entered data, wherein said validation comprises executing executable instructions comprised in said form validation engine and wherein said executable instructions identify one or more field markers embedded in said one or more fields of said form and call and execute one or more form validation functions upon said data in said one or more fields, respectively, and wherein said one or more functions comprise one or more validation criteria.
